(19) United States
(12) Patent Application Publication
(10) Pub. No.: US 2011/0235336 A1
(43) Pub. Date: Sep. 29, 2011

(54) DIFFUSING PLATE

(75) Inventors: Eugen Fritsch, Weingarten (DE); Sascha Piltz, Berlin (DE); Karen Twesten, Berlin (DE)

(73) Assignee: OSRAM GESELLSCHAFT MIT BESCHRAENKTER HAFTUNG, Muenchen (DE)

(21) Appl. No.: 13/133,153

(22) PCT Filed: Oct. 28, 2009
(86) PCT No.: PCT/EP09/64174

§ 371 Date: Jun. 7, 2011

(30) Foreign Application Priority Data
Dec. 8, 2008 (DE) 10 2008 060 969.2

(51) Int. Cl. F21V 13/10; G02B 5/02

(52) U.S. Cl. 362/307; 359/599

(57) ABSTRACT

A diffusing plate may include a transparent base body which has a first surface, the first surface being subdivided into facets, and in which an elevation or depression with a second, curved surface can be assigned to every facet, the facets having different geometric shapes, wherein the facets are assigned to several circular rings, in the sense that their center points lie on each of them.

### TECHNICAL FIELD

The invention relates to a diffusing plate as claimed in the preamble of claim 1. Such diffusing plates are used in particular as cover glasses for reflectors which are equipped with a light source. Light sources include filament lamps, discharge lamps or LED.

### PRIOR ART

A diffusing plate which is based on a hexagonal facet structure is known from DE-A 103 43 630 and EP-A 961 136.

### DESCRIPTION OF THE INVENTION

The object of the present invention is to provide a diffusing plate which avoids inhomogeneous luminous intensity or illuminance as far as possible.

This object is achieved by the characterizing features of claim 1.

Particularly advantageous embodiments are found in the dependent claims.

Reflector lamps with high pressure discharge lamps as a light source frequently have a problem in that luminous intensity or illuminance distribution are inhomogeneous with regard to light intensity and light color. The reason for this is to be found in the non-axially symmetrical uniform luminance distribution of the light source, for example, through the arc curvature or the deposition of metal halide condensate in the discharge vessel.

A customary method for reducing this effect consists of light refraction applied in addition to light reflection by means of a transparent diffusing plate. The diffusing plate has a large number of convex or concave curved lenses, the lens radius of which determines the expansion of the radiation angle of the light distribution curve (LVK). As a rule, each individual lens produces its own LVK, which should correspond to the final shape of the LVK in terms of its basic shape. The overlap of the individual lens LVKs then brings about the mixing of the different color values so that a homogeneous distribution of color values occurs in the far field of the LVK.

Until now cover glasses have frequently been encountered with lens facets with a uniform hexagonal shape. The uniformity of the lens shape is reflected in the luminous intensity distribution. This still permits identification of the hexagonal facet shape.

In order to obtain a symmetrical—and therefore as uniform as possible—luminous intensity distribution, it is known that the facet shape must have a polygonal and non-uniform shape.

The prior art is a diffusing plate with concave or convex curved lenses which have a hexagonal outer contour, the vertices of the lenses being on a common level (=flat diffusing plate) or a uniformly curved surface (=curved diffusing plate).

The hexagonal outer contour of the facet is produced when the center points of the lenses are uniformly distributed on hexagons, the widths across flats of the hexagons increasing by a constant amount, and the number of facets increasing by 6 with every hexagon. The area of the hexagonal facet is always the same size. The vertices of the hexagons each produce a series of facets on a line emanating radially from the center of the diffusing plate.

When using this design, hexagonal light distribution occurs in the optical far field according to FIG. 1b. This diffusing plate design is often used for reflector lamps.

At present only two relevant approaches are known for avoiding the hexagonal distribution characteristic.

Patent DE-B4 10343630 also relates to a hexagonal facet structure which is produced by the arrangement of the facets in a hexagon, as explained above. The basic approach here is that the “starting points” of the hexagons, which are on a radial line in the case of the diffusing plate according to the prior art, are distorted according to a certain mathematical rule. For example, the angle of distortion can increase quadratically as the distance from the center becomes greater. The facets overlap solely as a result of the distortion of the hexagons so that polygonal facets have now been produced from originally hexagonal facets.

In an additional exemplary embodiment described there the vertices of the facets are arranged along a spiral. The overlap of the interfaces of the initially circular facets results in the creation of the polygonal facet geometry.

According to the invention a completely different approach is now used for a diffusing plate with a polygonal facet shape, with the help of which luminous intensity distribution according to FIG. 1a is brought about.

The approach to the invention is characterized by an instruction with the help of which the polygonal, irregular facet shapes of the lenses are produced. The irregularity of the facet shape brings about uniform rotationally symmetrical light distribution.

The instruction is characterized by the following features:

The lenses are arranged in a circle around the diffusing plate center. At least two circles, preferably at least four arrangements of circles, are used.

The lenses are therefore arranged on circles so that immediately adjacent lenses at the same distance to the center of the diffusing plate would overlap if they were uniform hexagons.

The concentric arrangements of circles are in particular at the same distance from each other. This means that the diameter of all the circles increases to the outside by the same amount each time. In an additional embodiment they are at different distances.

The diffusing plate preferably has at least 6 and no more than 15 arrangements of circles.

On each arrangement of circles there is preferably at least one facet, its central coordinates xp, yp—this means the vertex of the facet lens with the curvature radius of the diffusing plate, wherein the diffusing plate need not necessarily be curved but can also be level—lies on a shared, radial line with the respective facets of the other arrangements of circles. For example, on every arrangement of circles at least one facet has the coordinate yp=0. This renders distortion unnecessary. The term central coordinate is taken to mean in particular the center of gravity of the polygon.

The number of facets per arrangement of circles rises as the diameter of the circle increases. Preferably it rises by a fixed amount. Normally and based on the concept of hexagonal facets according to the prior art it rises by 6 facets for each circle, with the exception of the transition from the central facet to the first circle. However, better uniformity is achieved if in the case of at least one arrangement of circles this rule is not adhered to from the second circle onward, and preferably onward to higher values. As an example a concept with eight circular rings is addressed in which the number of facets increases in accordance with the following guideline: 1-6-12-18-25-31-37-43). The best results are produced by a procedure in which the number of facets increases by 5 to 8.

All the lens surfaces, understood as regular hexagons, would overlap. No gaps remain between the facets.

In a preferred embodiment the spherical lenses are composed of the overlapping of spheres. The sphere or lens radius remains the same for each arrangement of circles. Starting from the center of the diffusing plate, the lens radius for each arrangement of circles may increase or decrease, with the result that there are at least three different lens radii per diffusing plate.

Only the vertices of the lenses must be on a level (=flat diffusing plate) or on a curve (=curved diffusing plate).

An additional embodiment (besides the selection of various lens radii) for obtaining different sized facet surfaces and consequently different polygonal facet shapes is produced by the axial arrangement of the center points of the spheres. If the center points of the spheres are not on a common level or curve, the same effect is produced as when different lens radii are selected.

Preferably the distances of the center points of all the facets of a circle are predetermined according to a certain rule: it is simplest if their distribution over the circumference is equidistant. Or if their distribution alternates at two predetermined distances so that every second facet is at a constant distance from the next facet but one.

The facets are preferably at least quadrilaterals and at most heptagons.

Individual polygons are preferably determined by the following rule: on the basis of circles as placeholders of the future polygons, which overlap extensively, the corners of the facets are placed in the center of the overlaps of at least three circles.

The polygonal, irregular outer contour of the lenses results in uniform, rotationally symmetrical light distribution in all of the individual distribution curves. Hexagonal light distribution according to the prior art is thus avoided (see FIG. 1).

The calculation rule for determining the center point coordinates xp and yp is comparatively simple compared with the solutions according to the prior art. In this context the manufacturing process of the plunger is also simpler.

The different radii of the lenses can be adjusted to the locally differing beam expansion produced by the basic reflector.

The shape of the central facet is insignificant for the present invention, in other words it does not matter that it forms a regular hexagon. The polygons presented here can also be replaced by bodies with contoured curves instead of straight connection lines. The term polygon is to be understood in this case as a sole reference to the number of corners.

The term facet here essentially means the two-dimensional approach, while the term lens in addition explicitly takes into account the spatial extent in the case of a curved diffusing plate.

### BRIEF DESCRIPTION OF THE DRAWINGS

Below the invention is to be explained in more detail on the basis of an exemplary embodiment. The figures show:

FIG. 1 the light distribution according to the invention (1a) and according to the prior art (1b);

FIG. 2 a diffusing plate according to in the prior art;

FIG. 3 a schematic diagram for the radial beam set;

FIG. 4 a schematic diagram for the creation of the facets;

FIG. 5 a schematic diagram of the expansion of the facets;

FIG. 6 a high-pressure discharge lamp with an inventive diffusing plate.

### PREFERRED EMBODIMENT OF THE INVENTION

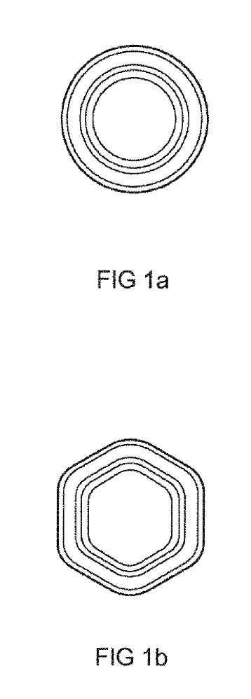

FIG. 1a is a diagram of the light distribution of an inventive diffusing plate. It is almost circular. In comparison FIG. 1b shows the light distribution of a known diffusing plate. It shows radial inhomogeneities above all in the border regions.

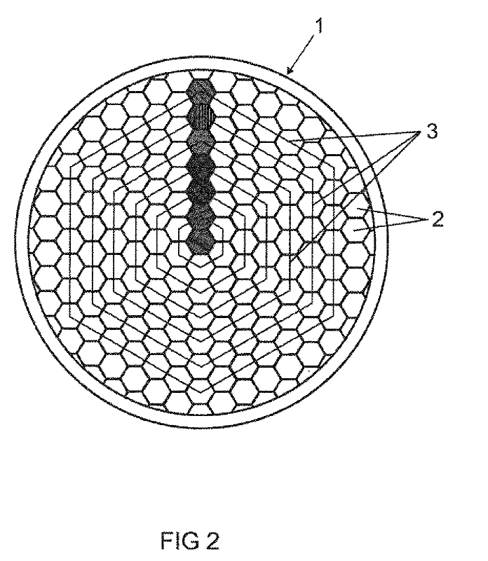

FIG. 2 shows a customary diffusing plate 1, having uniform hexagonal facets 2. The hexagonal symmetry of this arrangement is always retained in each ring 3 of facets and can ultimately be shown in the light distribution thus produced, see FIG. 1b.

The known rules are always based on this underlying framework which is modified appropriately if need be, see DE 103 43 630.

According to the invention, however, a system of circular rings is now taken as the starting point. There should be at least four circular rings. A practical upper limit is approximately 15.

An example of the table (Table 1) for five rings which are arranged around a central facet (here the central facet is in particular assumed to be a uniform hexagon) is shown below. A radial beam from facets with common coordinate xp is used for this. The variable a is the distance of the circular rings from each other. The coordinates of the facet of this central beam are given below (coordinate information relates to the center of gravity).

TABLE 1

| | Number | | | |
|---|---|---|---|---|
| Ring | of | | | Lens |
| number | facets | x-coordinate ⁱ⁾ | y-coordinate ⁱ⁾ | radius |
| 1 | n | 0 | y | R1 |
| 2 | n + 6 | 0 | y + a | R1 |
| 3 | n + 12 | 0 | y + 2a | R2 |
| 4 | n + 19 | 0 | y + 3a | R2 |
| 5 | n + 25 | 0 | y + 4a | R3 |

¹⁾ Coordinates of those facets which lie on a common radial axis.

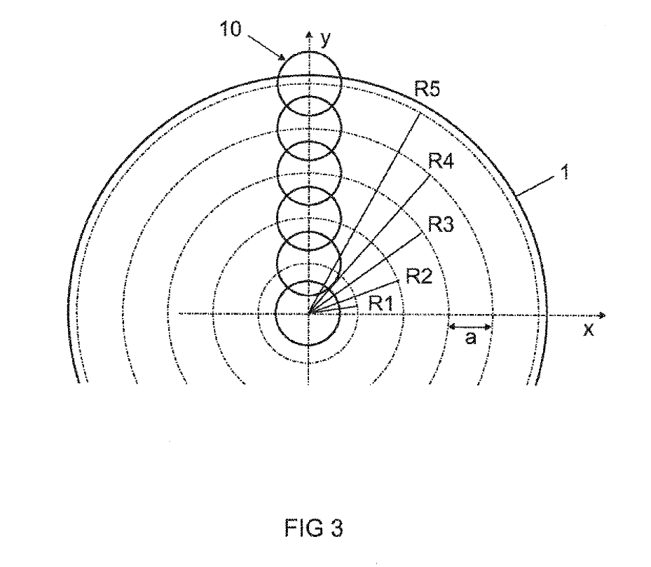

FIG. 3 shows the principle of the initially circular arrangement of lenses, wherein the circle distances a were each selected as the same size here. The radius of the individual circles is R1, R2, etc. Therefore here R5−R4=R4−R3=R3−R2=R2−R1=a applies.

In this way the center of gravity of the radial beam set 10 is initially defined using facets. The distances of the center points of the circular rings, here a, must at least be selected so that all the lenses which comprehensively fill the whole diffusing plate overlap.

In the next step the number of lenses per circular ring is determined, wherein preferably at least 5 and no more than 8 additional lenses are to be selected per subsequent circle in order to obtain the most uniform illumination possible. The distance rule for the lenses is also determined for each circle in the process: in particular uniform distance or alternating uniform distance, etc.

On the basis of this rule the corresponding lenses and their radii are now drawn in.

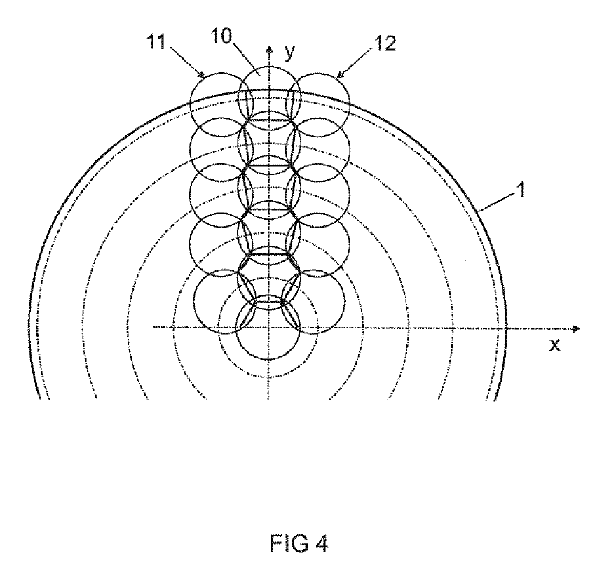

FIG. 4 now shows how the shape of the facets which are assigned to the radial beam set 10 arises, with account being taken of the radial beam set 10 and its left, 11, and right neighbors 12. The corners of the polygons are each placed in the center of gravity of overlapping lens surfaces here, provided that at least three lenses overlap, that is to say they have a common intersection. This should be at least punctiform.

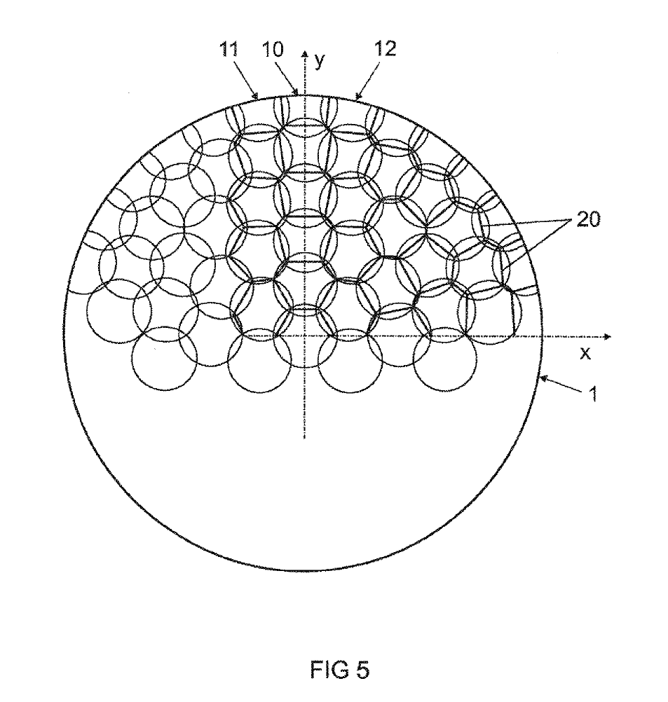

FIG. 5 now shows how this production rule is extended to additional facets which are outside the radial beam set 10. The rule described results in the generation of irregular, polygonal facets 20 and in the process even permits the special consideration of local inhomogeneities which arise as a result of special qualities of the light source or of the reflector.

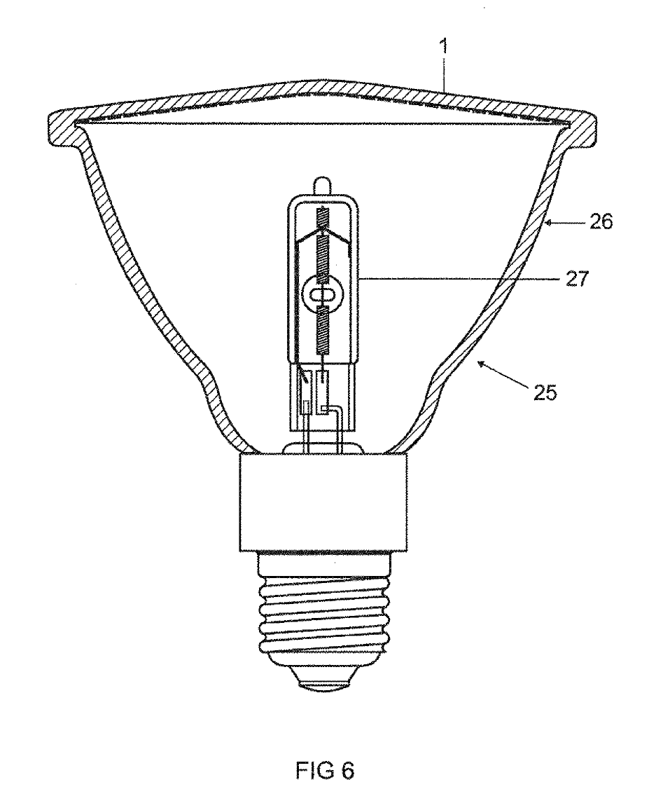

FIG. 6 shows a reflector lamp 25 with a PAR reflector 26 and a diffusing plate 1, which was created in accordance with such a rule. An integral lamp 27 is arranged in the reflector.

For the purposes of the invention a center point is assigned to every facet, and can be determined in different ways. In particular, but not necessarily, the center point is the center of gravity of the polygon formed by the facet. It can also simply be the vertex of the lens on the curvature radius of the diffusing plate.

In the concrete case of a reflector lamp, for example, the design of the diffusing plate is selected such that a customary PAR lamp with a given light source is given, the opening of which is defined by the dimensions of the diffusing plate. Then initially a relatively small number of circular rings are selected (as a rule four to 12, preferably 6 to 12) and a requirement set for the homogeneity of the light emitted. If this requirement cannot be met with the selected number of circular rings, the number of circular rings is gradually increased.

1. A diffusing plate, comprising:
a transparent base body which has a first surface, the first surface being subdivided into facets, and in which an elevation or depression with a second, curved surface can be assigned to every facet,
the facets having different geometric shapes,
wherein the facets are assigned to several circular rings, in the sense that their center points lie on each of them.

2. The diffusing plate as claimed in claim 1,
wherein four to 15 circular rings are formed.

3. The diffusing plate as claimed in claim 1,
wherein the distance a between two circular rings is constant, or does not differ by more than 50% from the other.

4. The diffusing plate as claimed in claim 1,
wherein the number of facets per circular ring of a given circular ring external to the next one increases.

5. The diffusing plate as claimed in claim 1,
wherein the distance of the center point of two facets on a circular ring is constant or two distances and alternate.

6. The diffusing plate as claimed in claim 1,
wherein the arrangement of the facets includes a central facet, emanating from which a radial beam is defined, on which there is one center point of a facet per circular ring.

7. The diffusing plate as claimed in claim 6,
wherein the arrangement of the facet takes the form that the following calculation rule is observed: a circular lens with a radius is first assigned to every facet, the lenses covering the diffusing plate comprehensively; then polygons are derived from them by providing vertices of the polygons at the places at which at least three lenses overlap, the center point of the common surface of the at least three lenses being selected as the vertex.

8. A reflector lamp with a light source and a reflector with an opening, the opening being closed by a diffusing plate, the diffusing plate comprising:
a transparent base body which has a first surface, the first surface being subdivided into facets, and in which an elevation or depression with a second, curved surface can be assigned to every facet,
the facets having different geometric shapes,
wherein the facets are assigned to several circular rings, in the sense that their center points lie on each of them.

9. The diffusing plate as claimed in claim 1,
wherein the facets have polygon shapes.

10. The diffusing plate as claimed in claim 4,
wherein the number of facets per circular ring of a given circular ring external to the next one increases by n, wherein 5≦n≦8.
